(19) United States
(12) Patent Application Publication
(10) Pub. No.: US 2003/0198202 A1
(43) Pub. Date: Oct. 23, 2003

(54) Selection of access point devices in a wireless communication network

(76) Inventor: Patrick Busch, Enschede (NL)

Correspondence Address: Docket Administrator (Room 3J-219), Lucent Technologies Inc., 101 Crawfords Corner Road, Holmdel, NJ, 07733-3030, US

(21) Appl. No.: 10/409,987

(22) Filed: Apr. 9, 2003

(30) Foreign Application Priority Data
Apr. 23, 2002 (GB) 0209266.6

(51) Int. Cl. H04Q 7/00

(52) U.S. Cl. 370/329

(57) ABSTRACT

A wireless communication network contains a plurality of spatially distributed access point devices and station devices. Each station device communicating in the network exclusively via an associated one of the access point devices. The station devices select the associated one of the access point devices dynamically. Selection involves

computing a respective measure of traffic load for each of the access point devices;

identifying, for respective ones of access point devices, a set of co-channel access point devices that operate in a same frequency channel as the respective one of the access point devices;

selecting the associated one of the access point devices dependent on a criterion based on the traffic load of the access point devices, so that, at least when part of the access point devices are equal on further criteria, if any, the associated one of access point devices is selected for which the co-channel access point devices have a least combined measure of traffic load of said part of the access point devices.

### CROSS REFERENCE TO RELATED APPLICATION

This application claims priority of Great Britain Application No. 0209266.6 filed on Apr. 23, 2003.

### FIELD OF THE INVENTION

The invention relates to a wireless communication network, a station for use in a wireless communication network and a method of operating such a network.

### BACKGROUND ART

European Patent Application No. EP 1156623 discloses a wireless communication network. The network allows devices to exchange messages (called frames) by wireless communication.

The network is organized as a group of cells. Each cell contains one device called an access point. Other devices, called stations, dynamically associate themselves with the cells. The stations in a cell communicate with the access point of the cell with which they are associated, but not directly with each other or with the access points of other cells. Each cell operates with frames carried by signals with frequencies in its own frequency channel. Spatially adjacent or overlapping cells generally use different frequency channels to minimize interference between the cells, but since only a limited number of frequency channels is available some cells will inevitably use the same frequency channels.

Each channel has only a limited transmission capacity. Within a cell only one device (station device or access point device) can transmit at a time. Devices have to wait with transmission while other devices in their cell are transmitting. If a device detects that it has started transmission simultaneously with a disturbing transmission from another device, a collision is said to have occurred and the device retry its transmission. In both cases transmission is delayed. Cell organization should minimize occurrence of these delays.

Each station selects one of the access points with which the station is able to communicate and associates itself with the selected access point. Of course, the station can only communicate with access points that are sufficiently close to the station to provide sufficient signal to noise ratio, but this may still leave room for choosing between access point devices. EP 1156623 describes how station devices make this choice dependent on two factors: received signal to noise ratio and traffic load of the access point devices. The station device determines the received signal to noise ratio of an access point device as the ratio between the signal strength with which the access point device is received by the station device and the signal strength of other access point devices. The traffic load of an access point device is monitored by the access point device itself and broadcast by the access point device.

Both received signal to noise ratio and traffic load affect the transmission capacity of an access point device. A low signal to noise ratio means that there is an increased risk of disturbed transmissions, which have to be retransmitted at the expense of bandwidth. A high traffic load means that transmissions may have to be delayed for a long time before they can be completed.

EP 1156623 describes how a station device, when choosing an access point device to associate with, computes a “Communication Quality and Load factor” (CQL) for each available access point device. The CQL which is a sum of the received signal to noise ratio for the access point device minus a measure of the traffic load of the device. The station associates with the access point device with the highest CQL. Thus, the station device may associate with an access point device with a less than optimal signal to noise ratio when the selected access point has a lower traffic load than an access point device with a higher signal to noise ratio. However, it has been found that this still leads to transmission delays. It has been found that in many practical networks it occurs that cells that operate in the same frequency channel disturb lead to collisions.

### SUMMARY OF THE INVENTION

Amongst others, it is an object of the invention to provide for an improved method of associating station devices with cells of a wireless transmission network.

According to the invention a station device selects the cell with which it associates dependent on the combined traffic load of cells that operate in the same frequency channel as a selected cell. Other things being equal, a cell with a minimum combined traffic load is preferably selected for association. Preferably, the associated access point station is selected using a combined traffic load for a particular access point device that is computed by summing the traffic loads of the access point devices that operate in the same frequency channel as the particular access point device. This allows a simple form of selection.

### BRIEF DESCRIPTIONS OF THE DRAWINGS

These and other objects and advantageous aspects of the network, devices and system according to the invention will be described in more detail using the following figures.

FIG. 1 shows a spatial arrangement of devices in a wireless network;

FIG. 2 shows a device for use in a wireless network; and

FIG. 3 shows a flow chart of a process for selecting an associated access point.

### DETAILED DESCRIPTION

FIG. 1 shows a spatial arrangement of devices 10, 12 in a wireless network. In a wireless network devices 10, 12 communicate with each other with wireless signals, preferably electromagnetic signals such as modulated microwave signals or infrared signals, but other types of signals, such as acoustic signals may be used as well. In a wireless network the spatial placement of the devices relative to one another is one of the factors that determines the attenuation with which signals from one device 10, 12 reach another device 10, 12.

The devices include access points devices 12 and station devices 10. During operation each access point device 12 may be associated with a number of station devices 10. Each access point device 12 handles all communication to and from the station devices 10 associated with it. The access point device may relay messages between the station devices and a wired network (not shown) or between different station devices.

Each access point device 12 has a certain maximum spatial range in which wireless signals from the access point device 12 can be received with sufficient strength by station devices. Conversely, signals from station devices 10 in the maximum spatial range can be received with sufficient strength by the access point device 12. The access point devices may be located so close to each other that their maximum spatial ranges overlap.

Each access point device 12 has an assigned frequency channel that is used for communication with the station devices 10 that are associated with the access point device 12. The frequency channels may be assigned to the access point devices 12 in any known way, for example manually upon installation of the access point device 12. Preferably, the frequency channels are assigned so that the access point devices 12 with overlapping spatial ranges are assigned different frequency channels. However, because only a limited number of frequency channels is available, in some configurations it may be unavoidable that the maximum spatial range of access point devices 12 with the same assigned frequency channel overlap.

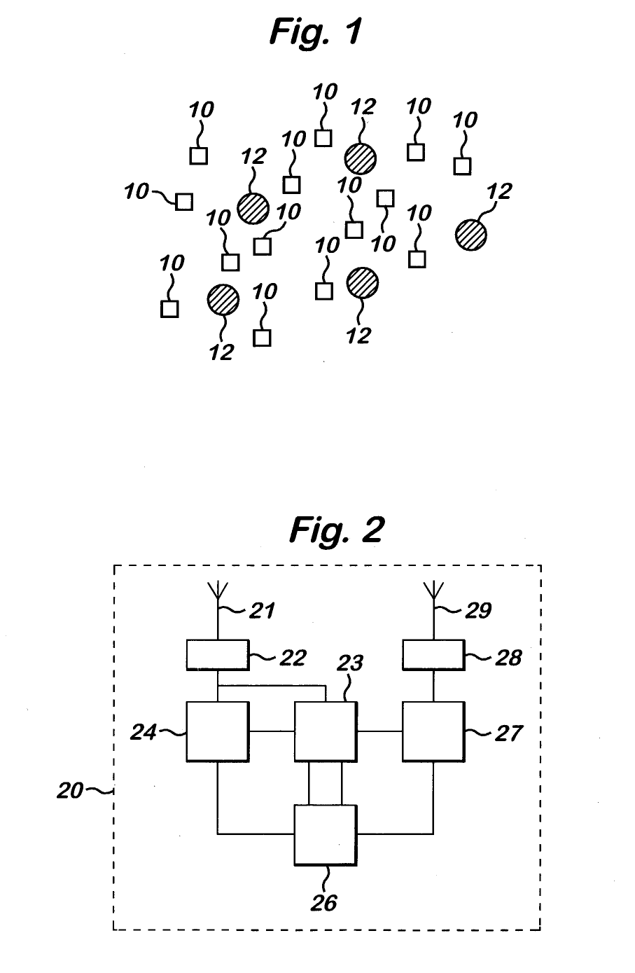

FIG. 2 shows an example of a device 20. The example applies to access point devices 12 as well as station devices 10. Device 20 contains a reception input 21 for wireless signals, a receiving circuit 22, a signal strength discriminator 22, a frame extractor circuit 24, a processing circuit 26, a frame insertion circuit 27, a transmitter circuit for wireless signals 28 and a transmission output 29 for wireless signals. The reception input 21 is coupled to the receiving circuit 22, which has an output coupled to the strength discriminator 22 and the frame extractor circuit 24. The strength discriminator has control outputs coupled to the frame extractor 24 and the frame insertion circuit 27. The processing circuit 26 has an input coupled to the frame extractor 24, an output coupled to the frame insertion circuit 27 and a threshold selection interface to strength discriminator 23. The frame insertion circuit is coupled to transmission output 29 via transmitter circuit 28.

In operation device 20 receives wireless signals at reception input 21. Receiving circuit 22 pre-processes the received signals, for example by amplifying the signal and filtering out signals outside a frequency band assigned to the device if the device is an access point device or to the access point device to which the device is associated if the device is a station device. Receiving circuit 22 may also convert the signal to a lower frequency. Strength discriminator 23 determines when signals with frames must be received or transmitted. Frame extractor 24 extracts information from frames that are modulated onto the signals from receiving circuit 22 and passes the extracted information to processing circuit 26. Frame extractor does so only when enabled to do so by strength discriminator 23.

Processing circuit 26 processes the received information and generates further information for transmission. Processing circuit 26 supplies the further information to frame insertion circuit 27, which generates a signal carrying a frame with the further information and supplies this signal to transmitter circuit 28. Frame insertion circuit 27 only does so when enabled to do so by strength discriminator 23.

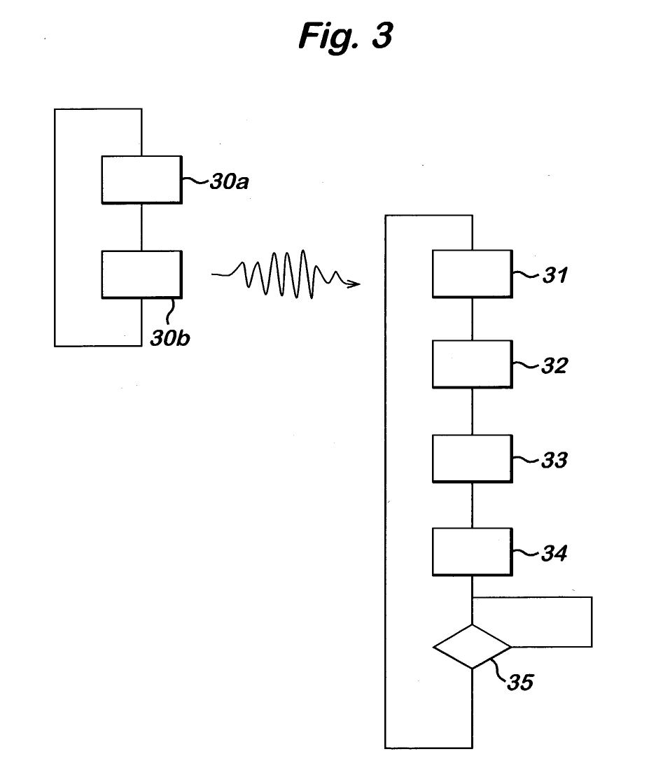

FIG. 3 shows a flow-chart of a method according to which the station devices 10 select automatically with which access point devices 12 the associate. The flow chart involves steps 30a, 30b executed by the access point devices 12 and steps 31-35 executed by the station devices.

In a first access point device step 30a, each access point device 12 computes a measure of its traffic load. This is preferably done by processing circuit 26. Processing circuit 26 computes the measure of traffic load for example by determining the fraction of time that messages are received and/or transmitted by the frame extractor 24 and frame insertion circuit 27 of the station device respectively. Alternatively, station device 12 computes the measure of traffic load by counting the number of station devices associated with the access point device 12. In a second access point device step 30b the access point device transmits a message with information about the computed measure of traffic load to the station devices 10.

In a first station device step 31, a station device 10 receives messages with information about the computed measure of traffic load from different access point devices 12. Preferably, this is realized using a probe transaction, in which the station device sends probe signals to the access point devices and the access point devices respond to the probe signals with probe response signals that include the information about the computed measure of traffic load.

In a second station device step 32 the station device 10 measures the signal level of each particular access point device 12 as received by receiving circuit 22 and the signal level of the noise that may disturb reception of the particular access point devices 10, that is, a typical (e.g. average or peak) signal level of signals other than signals of the particular access point device 12 in the frequency band used by the particular access point device 12, as received by receiving circuit 22.

In a third station device step 33, station device 10 (e.g. processing circuit 26 in the station device 10) computes a quality measure CCQL (Combined Communications Quality and Load) for each particular access point device 12. To compute the quality measure for a particular access point device 12, the station device computes the sum of the traffic loads of the access point devices 12 that use the same frequency channel as the particular access point device 12 and from which messages are received by the station device 10. The quality measure increases with the signal level for the particular access point device, decreases with its noise level and decreases with the combined traffic load of the access point devices 12 that use the same frequency channel as the particular access point device 12. An example of a formula for computing such a quality measure is

CCQL=SL−NL−CTL

Herein SL is the measured reception level of the signal from the particular access point device and NL is the measured noise level (both logarithmically) and CTL is the combined traffic load of the access point devices 12 that use the same frequency channel as the particular access point device 12. Instead of relying on the information on traffic load received from the access point device, an observed traffic load may be used by, as measured by the station device.

Another example a formula for computing such a quality measure is

CCQL=SL−NL−C*(AS−1)/AS

Where AS is the total number of station devices that is currently associated with the access point devices 12 that use the same frequency channel as the particular access point device 12. It will be appreciated that this formula for CCQL can be used generally also when only a single access point device 12 is considered in a frequency channel. The advantage of using the number of associated station devices 10 is that the measure of quality is not influenced by fluctuations in traffic load.

In a fourth station device step 34 the station device selects one of the access point device that has the higher measure of quality CCQL and executes a protocol to associate itself with the selected access point device 12. As a result, subsequently, all messages to and from the station device 10 will be passed via the selected access point device 12. As a result of the use of the combined traffic load of the access point devices 12 that use the same frequency channel as the particular access point device 12, other things being equal, the station device 10 will associate with preference to access point devices 12 that share their frequency channel with relatively few other access point devices 12 with heave traffic load. Other access point devices will be preferred only if such these access point devices 12 have a sufficiently higher signal to noise ratio (SL−NL).

In a fifth station device step 35 station device 10 monitors more or less continuously whether communication performance with the selected access point device remains above a minimum level. If not, the preceding steps of the flow chart are repeated.

It will be appreciated that not all steps of the flow-chart need be executed in the order shown, and that part of the steps may be executed in other devices than the station device 10. It should also be appreciated that other types of selecting the associated access point device dependent on the combined traffic load may be used, such as rejecting access point devices 12 devices which share their frequency channel with any access point device 12 that has a traffic load above a predetermined threshold.

1. A method of operating a wireless communication network, the network comprising a plurality of spatially distributed access point devices and station devices, each station device communicating in the network exclusively via an associated one of the access point devices, the station devices being arranged to select the associated one of the access point devices dynamically, said selecting comprising
computing a respective measure of traffic load for each of the access point devices;
identifying, for respective ones of access point devices, a set of co-channel access point devices that operate in a same frequency channel as the respective one of the access point devices;
selecting the associated one of the access point devices dependent on a criterion based on the traffic load of the access point devices, so that, at least when part of the access point devices are equal on further criteria, if any, the associated one of access point devices is selected for which the co-channel access point devices have a least combined measure of traffic load of said part of the access point devices:

2. A method of operating a wireless communication network according to claim 1, wherein said selecting is performed so that the method comprises computing, for each particular one of the access point devices, a measure of quality that increases in proportion to a sum of the measures of traffic loads of the co-channel access point devices of the particular one of the access point devices, and selecting the associated one of access point devices having a smallest value of said measure of quality, at least when the part of the access point devices are equal on further criteria.

3. A method of operating a wireless communication network according to claim 1, wherein said computing comprises summing said sum and a noise to signal ratio of the particular access point device.

4. A method according to claim 1, wherein the measure of traffic load of at least one of the access point devices is determined by counting a number of station point devices associated with said at least one of the access point devices.

5. A method according to claim 4, the method comprising transmitting information about the counted number of station devices from the at least one of the access point device to its associated station devices.

6. A wireless communication network, comprising a plurality of spatially distributed access point devices and station devices, each station device communicating in the network exclusively via an associated one of the access point devices, the station devices being arranged to select the associated one of the access point devices dynamically, the network comprising
computing circuitry arranged
to compute a respective measure of traffic load for each of the access point devices;
to identify, for respective ones of access point devices, a set of co-channel access point devices that operate in a same frequency channel as the respective one of the access point devices;
to select the associated one of the access point devices dependent on a criterion based on the traffic load of the access point devices, so that, at least when part of the access point devices are equal on further criteria, if any, the associated one of access point devices is selected for which the co-channel access point devices have a least combined measure of traffic load of said part of the access point devices.

7. A network according to claim 6, wherein each particular one of at least two of the access point devices are each arranged to compute the measure of traffic load of the particular one of the access point devices and to transmit information about the measure of traffic load to the associated station devices of the particular one of the access point devices.

8. A network according to claim 7, wherein the particular one of the access point devices is arranged to determine the measure of traffic load by counting a number of station point devices associated with the particular one of the access point devices.

9. An access point device for use in a network according to claim 7, arranged to compute the measure of traffic load of the access point device and to transmit information about the measure of traffic load to the associated station devices of the access point device.

10. A station device for use in a network according to claim 6, the station device being arranged
to receive information about the measure of traffic load of each particular one of the access point devices, that is receivable at the station device
to compute, for each particular one of the access point devices, a measure of quality that increases in proportion to a sum of the measures of traffic loads of the co-channel access point devices of the particular one of the access point devices,
to select the associated one of access point devices having a smallest value of said measure of quality, at least when the part of the access point devices are equal on further criteria, if any.
